(19) United States
(12) Patent Application Publication
(10) Pub. No.: US 2002/0096893 A1
(43) Pub. Date: Jul. 25, 2002

(54) Auxiliary lock structure

(75) Inventor: Wen Bin Wu, Kaohsiung Hsien (TW)

Correspondence Address: Bacon & Thomas, 625 Slaters Lane - 4th Floor, Alexandria, VA, 22314, US

(73) Assignee: TAIWAN FU HSING INDUSTRIAL CO. LTD., Kaohsiung Hsien (TW)

(21) Appl. No.: 09/765,616

(22) Filed: Jan. 22, 2001

(51) Int. Cl. E05B 15/02

(52) U.S. Cl. 292/347; 292/357

(57) ABSTRACT

An auxiliary lock structure includes a housing seat and a base plate each provided with a positioning hole for allowing a positioning member to be fixed to a door plate. The housing seat is provided with a protruding ring mating with a hole of the door plate. A pivot shaft rotatably passes through the central hole of the base plate and the axial hole of the housing seat. The central hole of the base plate has a periphery provided with protruding lugs. The pivot shaft is fitted with a control piece and an elastic member. The control piece is urged by the elastic member, so that the recesses of the control piece mate with the protruding lugs of the base plate so that the rotation knob can be positioned when its rotation stops.

### BACKGROUND OF THE INVENTION

1. Field of the Invention

The present invention relates to an auxiliary lock structure, and more particularly to an auxiliary lock structure having a greater strength to bear a greater breaking force, while the rotation knob can be exactly positioned when in use.

2. Description of the Related Prior Art

The closest prior art of which the applicant is aware is disclosed in the Taiwanese Patent Publication No. 346987, entitled by “Locking Structure of Auxiliary Lock”. The conventional auxiliary lock includes a rotation knob 34 for driving a driving plate 51 of a lock 5 to rotate. The rotation knob 34 drives a drive wheel 3 to rotate simultaneously. The drive wheel 3 has a non-circular outer diameter which is pressed and positioned by a rod-shaped elastic member 13, thereby stopping rotation of the rotation knob 34. In addition, the housing seat 1 and the base plate 2 have mating positioning holes for allowing passage of a bolt 11.

When the rotation knob 34 is rotated, it is pressed and fixed by the rod-shaped elastic member 13. Thus, the conventional auxiliary lock has a complicated construction, thereby increasing cost of fabrication. Meanwhile, when the bolt 11 is screwed, the housing seat 1 is easily deformed due to the force, so that the surface of the housing seat 1 is depressed, thereby decreasing the aesthetic quality thereof.

### SUMMARY OF THE INVENTION

The primary objective of the present invention is to provide an auxiliary lock structure which has a simple construction, and can be worked and manufactured conveniently. In addition, the rotation knob can be exactly positioned after rotation.

In accordance with the present invention, there is provided an auxiliary lock structure includes a housing seat and a base plate each provided with a positioning hole for allowing a positioning member to be fixed to a door plate. The housing seat is provided with a protruding ring mating with a hole of the door plate. A pivot shaft rotatably passes through the central hole of the base plate and the axial hole of the housing seat. The central hole of the base plate has a periphery provided with protruding lugs. The pivot shaft is fitted with a control piece and an elastic member. The control piece is urged by the elastic member, so that the recesses of the control piece mate with the protruding lugs of the base plate so that the rotation knob can be positioned when its rotation stops.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an auxiliary lock structure in accordance with the present invention;

FIG. 2 is a front plan cross-sectional assembly view of the auxiliary lock structure as shown in FIG. 1; and

FIG. 3 is a cross-sectional view of the auxiliary lock structure along the line 3-3 as shown in FIG. 2.

### DETAILED DESCRIPTION OF THE PREFERRED EMBODIMENTS

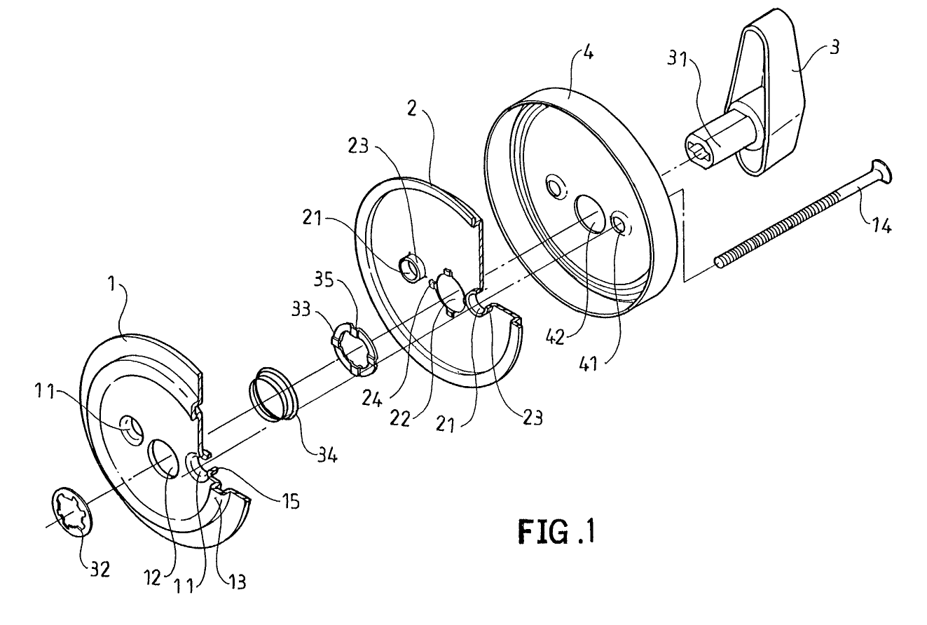

Referring to the drawings and initially to FIG. 1, an auxiliary lock structure in accordance with the present invention comprises a housing seat 1, a base plate 2, and a rotation knob 3.

The housing seat 1 made of a rigid metallic material, is provided with positioning holes 11 each allowing passage of a positioning member 14 such as a threaded rod or the like, so that the housing seat 1 can be secured to a door plate. For providing a better strength to the housing seat 1, the housing seat 1 itself is provided with a protruding ring 13 which may be matingly placed in a hole of the door plate, so that the housing seat 1 may form a better positioning effect with a better strength, thereby preventing a person from breaking the lock intentionally. The housing seat 1 has an axial hole 12 for allowing rotation of the rotation knob 3.

The base plate 2 is provided with positioning holes 21 each allowing passage of the positioning member 14, so that the base plate 2 is combined with the housing seat 1. For preventing incurring deformation due to the screwing action of the positioning member 14 when the base plate 2 is combined with the housing seat 1, the positioning hole 21 of the base plate 2 has a periphery provided with a protruding lip wall 23, while the positioning hole 11 of the housing seat 1 has a periphery provided with a protruding lip wall 15, whereby the protruding lip walls 15 and 23 abut with each other, or directly abut the base plate 2 or the housing seat 1. Thus, when the positioning member 14 is subjected to a force to rotate, the base plate 2 will not be depressed, thereby preventing decreasing the aesthetic quality thereof. The base plate 2 itself is provided with a central hole 22 which allows passage and rotation of the pivot shaft 31 of the rotation knob 3. The central hole 22 has a periphery provided with a plurality of protruding lugs 24. Preferably, the base plate 2 is provided with four protruding lugs 24 equally spaced from each other in an angular manner.

The rotation knob 3 may be held to rotate, and has a pivot shaft 31 rotatably passing through the central hole 22 of the base plate 2 and the axial hole 12 of the housing seat 1. For maintaining the rotation knob 3 to rotate in a positioning manner, the pivot shaft 31 has a distal end passing through the housing seat 1 to be snapped and limited by a snapping member 32 to prevent detachment of the pivot shaft 31. The pivot shaft 31 located between the housing seat 1 and the base plate 2 is fitted with a control piece 33 and an elastic member 34. The control piece 33 has a plurality of recesses 35 facing the protruding lugs 24 of the base plate 2. Preferably, the control piece 33 is provided with four recesses 35 equally spaced from each other in an angular manner. The control piece 33 is urged by the elastic member 34, so that the recesses 35 of the control piece 33 mate with the protruding lugs 24 of the base plate 2, thereby controlling the positioning effect of the rotation knob 3 after rotation.

For providing a better aesthetic appearance to the entire auxiliary lock, a face plate 4 is enclosed on the periphery of the base plate 2, and is provided with a central hole 42 for allowing passage of the pivot shaft 31 of the rotation knob 3, and two positioning holes 41 each allowing passage of the positioning members 14.

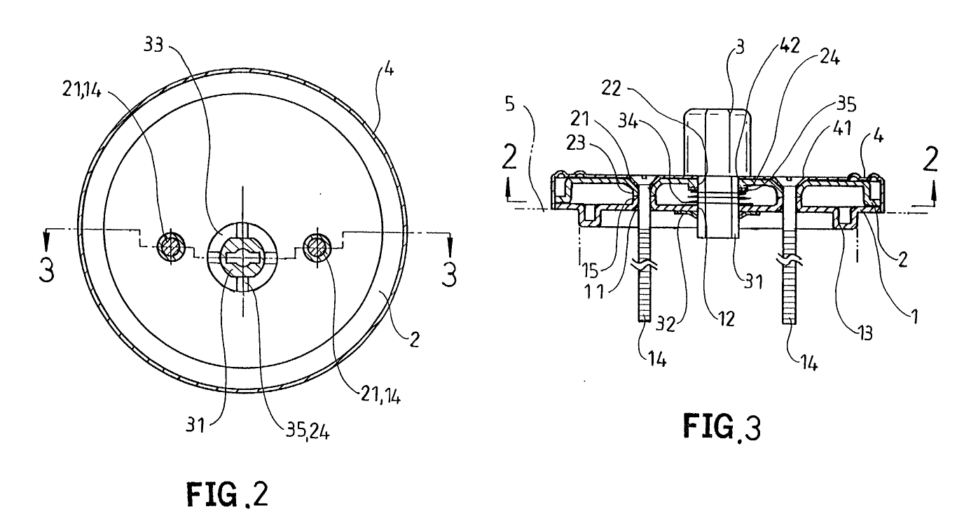

Referring to FIGS. 2 and 3, the auxiliary lock structure of the present invention is assembled, and is applied to the door plate 5. The protruding ring 13 of the housing seat 1 is matingly secured in the hole of the door plate 5, so that the auxiliary lock structure can be secured to the door plate 5. The pivot shaft 31 of the rotation knob 3 rotatably extends through the central hole 22 of the base plate 2 and the axial hole 12 of the housing seat 1, and is fitted with the control piece 33 and the elastic member 34. Thus, when the rotation knob 3 is rotated, the control piece 33 is locked on the protruding lugs 24 located at the periphery of the central hole 22 of the base plate 2, so that the rotation knob 3 can be positioned after rotation. The lip wall 15 of the positioning hole 11 of the housing seat 1 abut the lip wall 23 of the positioning hole 21 of the base plate 2, so that when the positioning member 14 is forced to rotate, the surface of the base plate 2 or the face plate 4 will not be depressed.

Accordingly, the auxiliary lock structure of the present invention has a simple construction, and can be worked and manufactured conveniently, while the base plate may be secured to the door plate during installation, thereby providing a better positioning effect. In addition, the surface of the base plate or the face plate will not be depressed. Further, the rotation knob can be exactly positioned after rotation.

Although the invention has been explained in relation to its preferred embodiment as mentioned above, it is to be understood that many other possible modifications and variations can be made without departing from the scope of the present invention. It is, therefore, contemplated that the appended claim(s) will cover such modifications and variations that fall within the true scope of the invention.

What is claimed is:

1. An auxiliary lock structure, comprising:
a housing seat, provided with a positioning hole for fixing of a positioning member, the housing seat having an axial hole and a protruding ring;
a base plate, provided with a positioning hole for allowing passage of the positioning member which is combined with the housing seat, the base plate having a central hole, the central hole having a periphery provided with a plurality of protruding lugs;
a rotation knob, having a pivot shaft passing through the central hole of the base plate and the axial hole of the housing seat, and being limited by a snapping member to prevent detachment, the pivot shaft located between the housing seat and the base plate being fitted with a control piece and an elastic member, the control piece having a plurality of recesses facing the protruding lugs of the base plate, the control piece being urged by the elastic member, so that the recesses mate with the protruding lugs;
the positioning hole of the housing seat and/or the base plate having a periphery provided with protruding lip walls, the lip walls abutting opposite base plate or housing seat, or abutting with each other.

2. The auxiliary lock structure as claimed in claim 1, wherein the housing seat is provided with an annular protruding ring, the protruding ring may mate with a hole of a door plate.

3. The auxiliary lock structure as claimed in claim 1, wherein the base plate is provided with four protruding lugs equally spaced from each other in an angular manner.

4. The auxiliary lock structure as claimed in claim 1, wherein the control piece is provided with four recesses equally spaced from each other in an angular manner.
